(19) United States
(12) Patent Application Publication
(10) Pub. No.: US 2005/0000128 A1
(43) Pub. Date: Jan. 6, 2005

(54) Box body having a grating

(76) Inventor: Shih Ping Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/609,378

(22) Filed: Jul. 1, 2003

(51) Int. Cl. G03B 25/02

(52) U.S. Cl. 40/454

(57) ABSTRACT

A box body having a grating has a plurality of side faces, at least an upper cover face and at least a lower cover face. The side faces, the upper cover face and the lower cover face form at least a receiving space. At least two side faces of the box body have the grating, which faces outside the box body. The side faces having the grating have an image layer through which movable images or three-dimensional images can be displayed. At least a side face of the box body has an anti-piracy region. A barcode image layer can also be added. The region opposite to the barcode image layer has no grating.

### BACKGROUND OF THE INVENTION

1. Field of the Invention

The present invention relates to a box body having a grating and, more particularly, to a box body capable of displaying movable images or three-dimensional images for enhancing fun.

2. Description of Related Art

Techniques of applying a grating to display movable images or three-dimensional images have been developed for many years. U.S. Pat. No. 5,695,346 discloses many applications. Reference is also made to U.S. Pat. No. 4,935,335 for the principle of this technique. A grating is usually made of plastic or resin. The function of a grating is to let incident light generate periodic amplitude or phase variations. The most common grating is a lenticular lens array. There are also other shapes, e.g., triangles or composite striations (called moiré) formed by overlapping two different striations. A grating is seldom applied to a whole box body. Instead, a grating is mainly added on some face of the box body to let some other face be able to display movable images or three-dimensional images.

PROC Pat. No. 00259279.7 discloses a lenticular lens array applied to a whole box body. U.S. Pat. No. 5,695,346 discloses a box display assembly in the text description of FIG. 162 thereof.

However, the problem of impracticality arises when applying a grating material to a whole box body. For instance, in the management of commercial articles, barcodes are usually printed on the packages. In order to allow barcode readers to read barcodes, barcode labels are pasted on the exterior of the box body of the grating material, hence affecting the quality of the box body. Besides, no one has applied a grating material to a whole box body for an anti-piracy function. Moreover, no one has applied a grating material to a whole box body for containing a liquor bottle due to the insufficient shock absorption of the grating material.

### SUMMARY OF THE INVENTION

The primary object of the present invention is to provide a box body having a grating and also having anti-piracy interlaced striations.

Another object of the present invention is to provide a box body having a grating and also having the function of displaying barcodes so that barcode readers can correctly read the barcodes.

Yet another object of the present invention is to provide a box body having a grating, wherein at least a shock absorption pad is provided in a receiving space of the box body to protect an article like a liquor bottle in the box body.

To achieve the above objects, a box body having a grating of the present invention comprises a plurality of side faces, at least an upper cover face and at least a lower cover face. The side faces, the upper cover face and the lower cover face form at least a receiving space. At least two side faces of the box body have the grating, which faces the outside of the box body. The side faces with the grating have image layers through which movable images or three-dimensional images can be displayed. At least a side face of the box body has an anti-piracy region (e.g., a grating with interlaced striations). A barcode image layer can also be added thereon. The region opposite to the barcode image layer has no grating.

If the box body is primarily made of a grating material, because the shock absorption effect thereof is bad (inferior to a cardboard), at least a shock absorption pad is preferably added in the receiving space to protect an article such as a liquor bottle in the box body.

### BRIEF DESCRIPTION OF THE DRAWINGS

The various objects and advantages of the present invention will be more readily understood from the following detailed description when read in conjunction with the appended drawings, in which:

FIG. 1 is a schematic, unfolded view of the box body having a grating of the present invention;

FIG. 2 is a schematic, enlarged cross-sectional view of a slab of the box body of the present invention;

FIG. 3 is a schematic, enlarged cross-sectional view of a slab of the box body according to another embodiment of the present invention;

FIG. 4 is a schematic, perspective view of the box body of the present invention;

FIG. 5 is a schematic view of the box body from a viewing angle;

FIG. 6 is a schematic view of the box body from another viewing angle;

FIG. 7 is a schematic, enlarged planar view of the region having a barcode image layer of the present invention; and

FIG. 8 is a schematic, cross-sectional view along line A-A in FIG. 7.

### DETAILED DESCRIPTION OF THE PREFERRED EMBODIMENTS

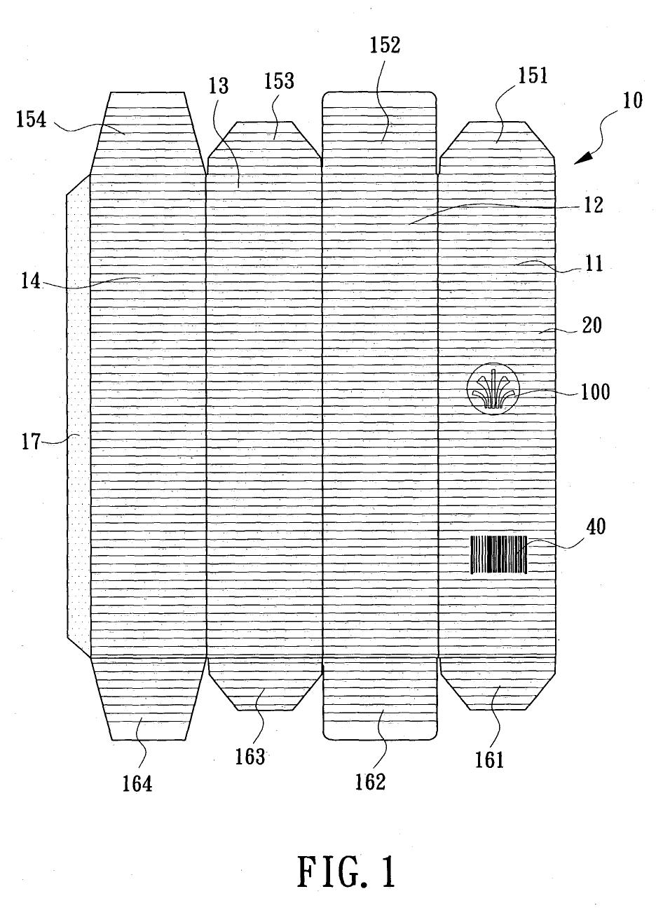

FIG. 1 is an unfolded view of a box body 10 having a grating of the present invention. This embodiment is exemplified with a rectangular box body 10. Before assembly, the box body 10 is a slab 20 comprising four side faces 11-14, four upper cover faces 151-154 (or less than four upper cover faces depending on the design of box body with the simplest one having only an upper cover face) and four lower cover faces 161-164 (or less than four lower cover faces depending on the design of box body with the simplest one having a lower cover face). The edge of the slab usually comprises one or more adhesion regions 17 so that the slab 20 can be conveniently bent and then assembled into the box body 10.

An anti-piracy region 100 and a barcode image layer 40 (described below) are disposed at predetermined places of the slab 20. The anti-piracy region 100 can display a larger depth of field making copying difficult, and can adopt a grating with interlaced striations. If a pirate does not duplicate the image 100% accurately a 1% error of image results in a much larger error through the grating with interlaced striations. The more similar the image, the greater the error unless the image is 100% correct. If the image is dissimilar, it is easy to discriminate between true and false.

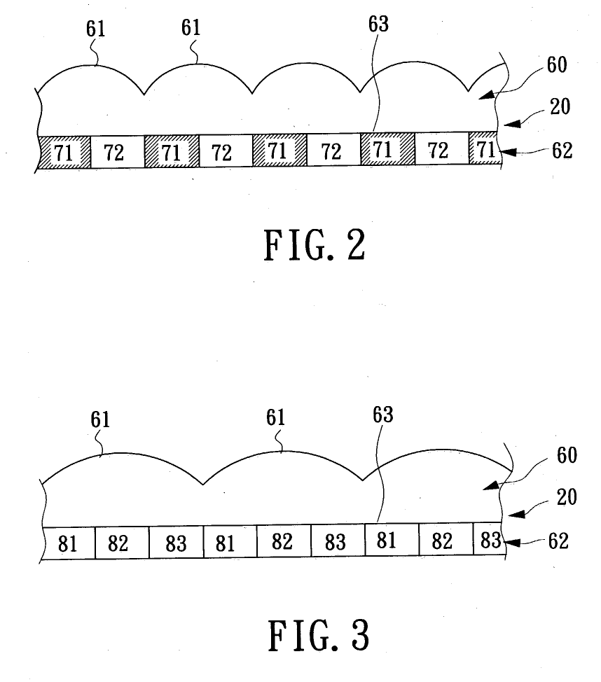

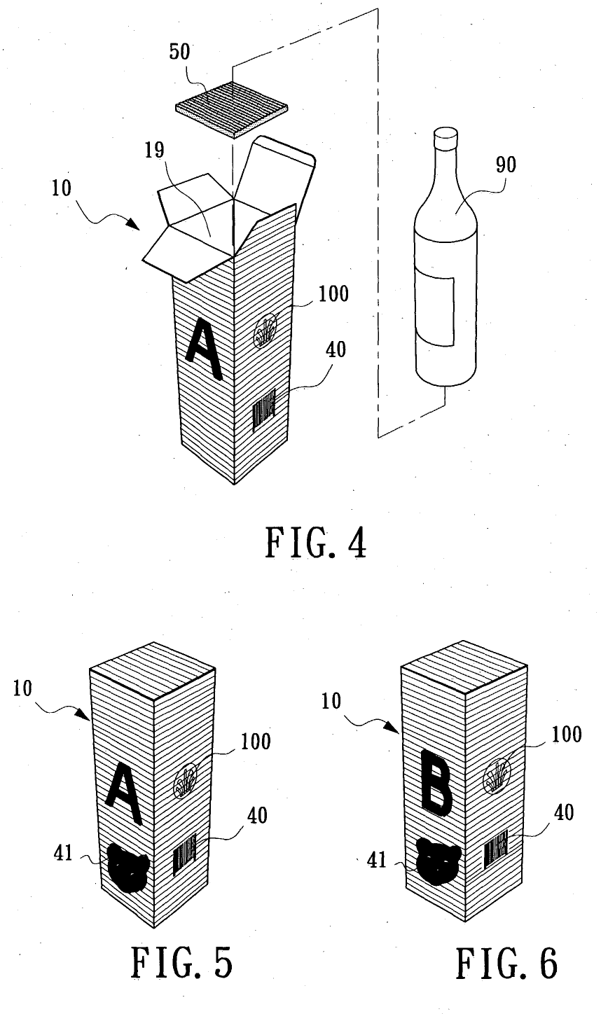

As shown in FIG. 2, the slab 20 basically comprises a grating 60 (transparent material having lenticular striations) and an image layer 62. FIGS. 2 and 3 show a lenticular lens array. However, the grating 60 is not limited to the lenticular lens array, and can be one with interlaced striations. The grating 60 faces the outside of the box body 10 (reference is also made to FIGS. 4 to 6) so that the image layer 62 can show movable images or three-dimensional images through the grating 60.

The grating 60 is made of transparent resin or plastic material, and has a plurality of micro lenticles 61 (exemplified with a lenticular lens array). On the other side of the lenticles 61 is a flat surface 63. The image layer 62 can be first printed on a paper or other material and then adhered onto the flat surface 63 of the grating 60, or the image layer 62 can be directly printed on the flat surface 63.

The image layer 62 in FIG. 2 is the most common one having two interlaced images 71 and 72. For instance, the image 71 shows an “A” while the image 72 shows a “B”. Viewed via the grating 60, one sees the “A” at some viewing angles and the “B” at some other viewing angles. This is called a movable image (animations are also included in the movable images). Of course, the number of interlaced images is not necessarily two. For instance, FIG. 3 shows three interlaced images 81, 82 and 83.

In addition to displaying movable images, the image layer 62 can also display three-dimensional images. For instance, if the image seen by the right eye is photographed and then displayed by the image 71 and the image seen by the left eye is photographed and then displayed by the image 72, a three dimensional object will be seen via the grating 60.

The above technique of displaying movable or three-dimensional images via the: grating 60 is well known in the prior art and thus will not be further described. It should be noted that, however, although most regions of the slab 20 have the grating 60, it is also feasible that only some portions of the slab 20 have the grating 60 (e.g., only some side faces have the grating 60). The image layer 62 is not necessarily interlaced images. According to the design of the appearance of the box body 10, it is feasible that some portions of the image layer 62 are interlaced images (for displaying movable or three-dimensional images) while some portions thereof are common images. For instance, the slab 20 has a barcode image layer 40 (FIG. 1) composed of non-interlaced images at a predetermined place thereof.

As, shown in FIG. 4, the box body 10 has a receiving space 19. A liquor bottle 90 can be packed into the receiving space 19. If the slab 20 is primarily made of the grating 60, the image layer 62 is very thin, and in order to protect the article such as liquor bottle 90 in the box body 10, a shock absorption pad 50 is preferably provided. In this embodiment, the shock absorption pad 50 is placed on the lower cover face. Of course, the shock absorption pad 50 can be designed to be very large to encompass all the receiving space 19 so as to let the box body 10 be safer.

FIG. 5 is a view of the box body 10 from some viewing angle, wherein an “A” and a three-dimensional image 41 are seen. FIG. 6 is a view of the box body from another viewing angle, wherein the “A” becomes a “B” and the three-dimensional image 41 also changes.

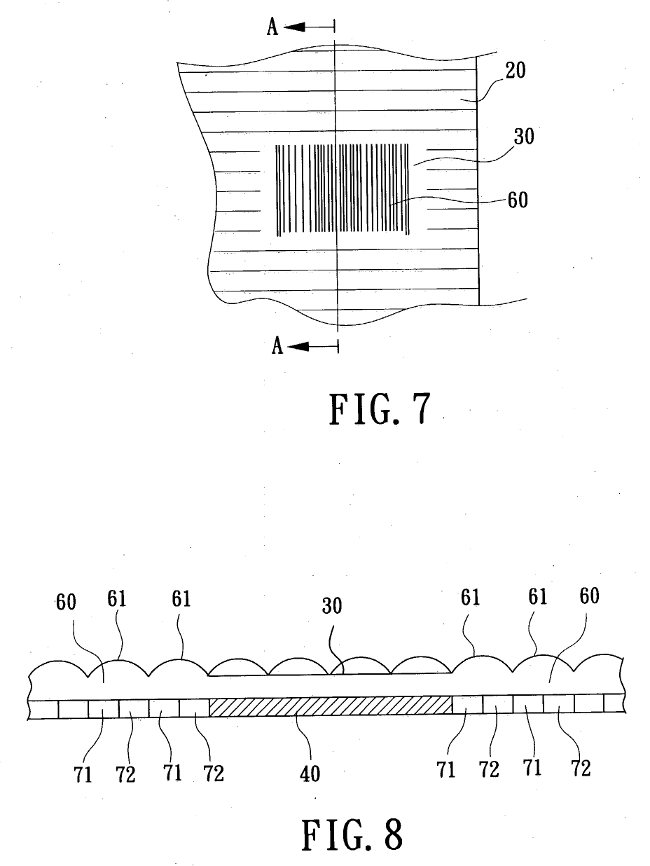

Reference is simultaneously made to FIGS. 7 and 8. The region opposite the barcode image layer 40 has no grating 60, and is a flat surface 30. The basic reason is that if the region opposite to the barcode image layer 40 also has the grating 60, errors may more probably occur when a barcode reader reads the barcode (a line barcode or a two-dimensional barcode). Of course, if the barcode image layer 40 is originally located in a region having no grating 60, it is not necessary to process the grating 60. However, if most regions of the slab 20 of the box body 10 adopt the grating 60, a lenticular sheet with a grating spread all over the sheet is preferably first selected as the basic material of the slab 20 and then the image layer 62 is added thereon. Next, the lenticles 61 are separately removed in the region opposite the barcode image layer 40. For instance, the lenticles 61 the region opposite the barcode image layer 40 can be heated and then pressed to become a flat surface 30 so that a barcode reader can correctly read the barcode.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A box body having a grating comprising
a plurality of side faces, at least an upper cover face and at least a lower cover face, said side faces, said upper cover face and said lower cover face forming at least a receiving space, at least two of said side faces of said box body having the grating, which faces outside said box body, said side faces having the grating comprising an image layer, said image layer being capable of displaying movable images or three-dimensional images via the grating, at least one of said side faces of said box body having an anti-piracy region.

2. The box body having a grating as claimed in claim 1, wherein all said side faces of said box body have the grating and the grating faces outside said box body.

3. The box body having a grating as claimed in claim 2, wherein said upper cover face and said lower cover face have the grating.

4. The box body having a grating as claimed in claim 1, wherein at least a shock absorption pad is provided in said receiving space.

5. The box body having a grating as claimed in claim 4, wherein said shock absorption pad is placed on said lower cover face.

6. The box body having a grating as claimed in claim 1, wherein at least one of said side faces of said box body has a barcode image layer, and the region opposite said barcode image layer has no grating.

7. The box body having a grating as claimed in claim 1, wherein said box body is used to pack a liquor bottle.

8. The box body having a grating as claimed in claim 1, wherein said anti-piracy region adopts a grating with interlaced striations.
